(19) United States
(12) Patent Application Publication
(10) Pub. No.: US 2012/0075476 A1
(43) Pub. Date: Mar. 29, 2012

(54) SURVEILLANCE SYSTEM

(75) Inventor: MING-YUAN HSU, Tu-Cheng (TW)

(73) Assignee: HON HAI PRECISION INDUSTRY CO., LTD., Tu-Cheng (TW)

(21) Appl. No.: 13/008,032

(22) Filed: Jan. 18, 2011

(30) Foreign Application Priority Data
Sep. 23, 2010 (TW) 99132242

(51) Int. Cl. H04N 7/18

(52) U.S. Cl. 348/159; 348/E07.085

(57) ABSTRACT

A surveillance system includes cameras, first modems, and a recorder. The camera captures images and outputs video signals. The first modems are connected to the cameras correspondingly and configured for modulation of the video signals from the cameras. The recorder is connected to the first modems. The recorder includes a second modem, an input portion, a processor, and a power supply. The second modem individually connects to the first modems. The input portion, the processor, and the power supply connect to the second modem. The second modern demodulates the modulated video signals from the first modems and sends the demodulated video signals to the processor. The second modern modulates control signals from the input portion and sends the modulated control signals to the first modems. The first moderns demodulate the modulated control signals and send the demodulated control signals to the cameras.

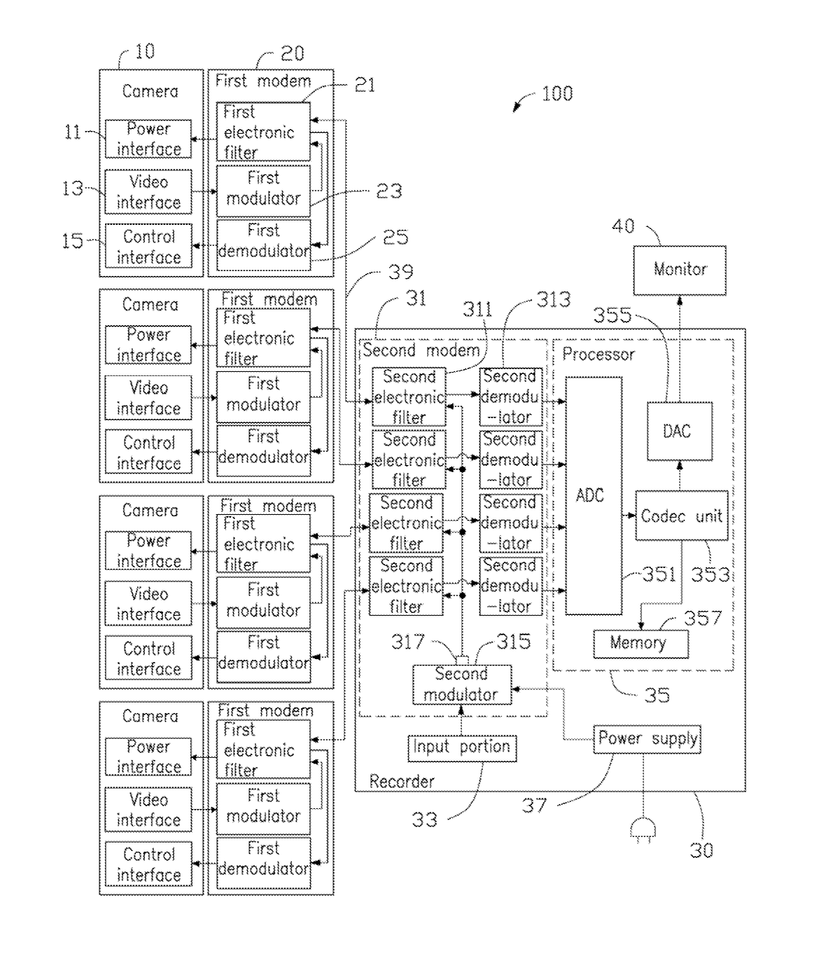

### BACKGROUND

1. Technical Field

The present disclosure relates to a surveillance system.

2. Description of Related Art

Security cameras usually employed in a conventional surveillance system are commonly connected to a digital video recorder (DVR) via a number of coaxial cables, to respectively transmit the video signals of the cameras to the DVR. During a working state, each camera is powered by a singular power source, for example, a 24V alternating current (AC) power source. As a result, the cost for installing the surveillance system increases since the facilities of power source cannot be reduced. Furthermore, the management of the power source also may be complicated.

Therefore, it is desirable to provide a new surveillance system, which can overcome the above-mentioned problems.

### BRIEF DESCRIPTION OF THE FIGURE

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

The FIGURE is a schematic diagram of one embodiment of a surveillance system.

### DETAILED DESCRIPTION

Embodiments of the present disclosure will now be described in detail below, with reference to the accompanying drawing.

Referring to the FIGURE, a block diagram of a surveillance system 100 in accordance with one embodiment is illustrated. The surveillance system 100 includes four security cameras 10, four first modems 20, a recorder 30, and a monitor 40. The cameras 10 are electrically connected to the recorder 30 via the corresponding first modems 20 and configured for capturing images of a monitored area, and transmitting the images to the recorder 30. The recorder 30 is electrically connected to the monitor 40, and the monitor 40 displays the images captured by the cameras 10.

The surveillance system 100 can have less or more cameras 10, first modems 20, or monitors 40, for example, 2, 3 or more than 4.

Each camera 10 includes a power interface 11 for drawing power from a peripheral power supply 37 (described below), a video interface 13 for outputting a number of video signals, and a control interface 15 for inputting a number of control signals according to a user's operation, to control the camera 10 to implement functions. In this embodiment, the power interface 11 can receive a 24V voltage input from the power supply 37, and each camera 10 can implement a pan-tilt-zoom (PTZ) function. The control signals satisfy a RS-485 protocol.

The first modems 20 are electrically connected to the cameras 10. In other embodiments, the first modems 20 can be internal in the camera 10.

In detail, each first modem 20 includes a first electronic filter 21, a first modulator 23, and a first demodulator 25. The first modulator 23 and the first demodulator 25 are both connected to the first electronic filter 21. The output of the first electronic filter 21 is connected to the power interface 11, and the input of the first modulator 23 is connected to the video interface 13, while the output of the first demodulator 25 is connected to the control interface 15.

In this embodiment, the recorder 30 is a digital video recorder (DVR). The recorder 30 includes a second modem 31, an input portion 33, a processor 35, and a power supply 37. Each of the input portion 33, the processor 35, and the power supply 37 are connected to the second modem 31 to further connect to the first modems 20. In the present embodiment, the second modem 31 is individually connected to the first modems 20 via the coaxial cables 39.

The second modem 31 includes four second electronic filters 311, four second demodulators 313, and a second modulator 315. Each second demodulator 313 is connected to the corresponding second electronic filter 311. The second modulator 315 is individually connected to the second electronic filters 311. In this embodiment, the second modulator 315 includes a divider 317, which has a number of interfaces connecting to the second electronic filters 311. The input portion 33 and the power supply 37 are both connected to the second modulator 315. Each second electronic filter 311 is correspondingly connected to the first electronic filter 21 via the corresponding coaxial cable 39.

In this embodiment, the input portion 33 connects to an input device (not shown), such as a touch panel or a keyboard via a RS-485 cable.

The processor 35 includes an analog-to-digital converter (ADC) 351, a codec unit 353, a digital-to-analog converter (DAC) 355, and a memory 357. The ADC 351 is individually connected to all of the second demodulators 313. The codec unit 353 is connected to the ADC 351, the DAC 355, and the memory 357. The DAC 355 is connected to the monitor 40.

The first modems 20 are configured for demodulating the video signals that are output from the video interface 13 to be standard signals. The standard signals can be transmitted to the recorder 30 via the coaxial cables 39. In detail, the first modulator 23 of the first modems 20 can transmit a number of video signals to the first electronic filter 21. Consequently, the frequency of the video signals can be first modulated by the first modulator 23 to be a standard frequency, and then the noise of the standard signals is efficiently and sufficiently filtered by the first electronic filter 21. After that, the modulated and filtered video signals are transmitted to the recorder 30 via the coaxial cables 39.

Due to an inherit function of the coaxial cables 39 for freely transmitting analog signals and/or digital signals therein, the video signals modulated/demodulated by the first modem 20 and/or the second modem 31 can be transmitted between the first modem 20 and the second modem 31. The second electronic filter 311 can further filter the noise of the video signals. The second demodulator 313 receives the video signals and recovers the video signals, and then transmits the recovered video signals to the processor 35.

The ADC 351 is configured for receiving the analog video signals from the second demodulator 313 and converting the video signals to digital signals. The codec unit 353 is configured for transmitting the digital signals to the memory 357 for storage, or to the DAC 355 to further convert the digital signals into analog signals. The analog signals can be recovered to be images displayed on the monitor 40.

When the power supply 37 is started, the power signals, e.g. current signals, are modulated by the second modulator 315 to be standard power signals in predetermined frequency. Then, the noise of the standard power signals are filtered by the second electronic filter 311 and further filtered by the first electronic filter 21. Sequentially, a number of modulated and filtered standard power signals can be provided to the cameras 10.

In addition, when a control signal is input to the input portion 33, the second modulator 315 mixes the current signals and the control signal to be a mixed signal, and the second modulator 315 further modulates the frequency of the mixed signal to be standard. The mixed signal is filtered by the second electronic filter 311 and then flows to the first electronic filter 21 via the axial cables 39. The first electronic filter 21 recovers the mixed signal to the standard power signals and the control signal. The standard power signals are transmitted to the power interface 11, and the control signal is transmitted to the first demodulator 25. The first demodulator 25 demodulates the control signal and further transmits the demodulated control signal to the cameras 10 through the control interface 15. As such, the cameras 10 can be controlled to implement the functions by the control signal.

While various exemplary embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A surveillance system comprising:
a plurality of cameras configured for capturing images and outputting video signals;
a plurality of first modems connected to the cameras correspondingly and configured for modulating the video signals from the cameras; and
a recorder electrically connected to the first modems and comprising a second modem, an input portion, a processor, and a power supply, the second modem individually connecting to the first modems, and the input portion, the processor, and the power supply connecting to the second modem;
wherein the second modern is configured for demodulating the modulated video signals from the first modems and sending the demodulated video signals to the processor; the second modern is also configured for modulating control signals from the input portion and sending the modulated control signals to the first modems; the first moderns are configured for demodulating the modulated control signals and sending the demodulated control signals to the cameras.

2. The surveillance system as claimed in claim 1, further comprising a monitor connected to the recorder for displaying the images.

3. The surveillance system as claimed in claim 1, wherein each camera comprises a power interface for drawing power from the power supply, a video interface for outputting the video signals, and a control interface for inputting the control signals from a user's operation to control the camera to implement functions.

4. The surveillance system as claimed in claim 3, wherein each first modem comprises a first electronic filter, a first modulator, and a first demodulator, the output of the first electronic filter is connected to the power interface and the first demodulator, the input of the first modulator is connected to the video interface, the output of the first modulator is connected to the first electronic filter, the output of the first demodulator is connected to the control interface.

5. The surveillance system as claimed in claim 3, wherein the second modem comprises a plurality of second electronic filters, a plurality of second demodulators, and a second modulator, the second electronic filters are correspondingly connected to the first electronic filters, the second demodulators are correspondingly connected to the second electronic filters, the second modulator is individually connected to the second electronic filters.

6. The surveillance system as claimed in claim 5, wherein the second modulator comprises a divider connected to the second electronic filters.

7. The surveillance system as claimed in claim 5, wherein the input portion and the power supply are both connected to the second modulator.

8. The surveillance system as claimed in claim 5, wherein the second demodulators are connected to the processor.

9. The surveillance system as claimed in claim 8, wherein the processor comprises an analog-to-digital converter (ADC), a codec unit, a digital-to-analog converter (DAC), and a memory, the ADC is configured for receiving the demodulated video signals from the second demodulators and converting the demodulated video signals into digital signals, the codec unit is configured for transmitting the digital signals to be stored in the memory, or to the DAC to further convert the digital signals into analog signals.

10. A surveillance system comprising:
one camera configured for capturing images and outputting video signals;
one first modem in communication with the camera and configured for modulating the video signals from the camera;
a recorder connected to the first modem via one coaxial cable and comprising one second modem, an input portion, a processor, and a power supply, the second modem connecting to the first modem via the coaxial cable and configured for demodulating the modulated video signals from the first modem, the input portion connecting to the second modem for providing a control signal thereto, the processor connecting to the second modem for receiving the demodulated video signals output from the second modem, and the power supply connecting to the second modem for powering the surveillance system; and
at least one monitor connected to the recorder for displaying the images.
